(19) United States
(12) Patent Application Publication
(10) Pub. No.: US 2026/0342744 A1
(43) Pub. Date: Oct. 29, 2026

(54) METHOD AND NETWORK DEVICE FOR MONITORING DATA FLOWS ON COMPUTER NETWORK

(71) Applicant: National Yang Ming Chiao Tung University, Hsinchu City (TW)

(72) Inventors: Shie-Yuan WANG, Hsinchu City (TW); Tzu-Ching LIN, New Taipei City (TW)

(21) Appl. No.: 19/331,490

(22) Filed: Sep. 17, 2025

(30) Foreign Application Priority Data
Apr. 29, 2025 (TW) 114116073

(51) Int. Cl. H04L 49/00; H04L 1/1812; H04L 43/02; H04L 43/0894; H04L 47/2483; H04L 69/22

(52) U.S. Cl. CPC H04L 49/3009; H04L 1/1816; H04L 43/02; H04L 43/0894; H04L 47/2483; H04L 69/22

(57) ABSTRACT

A method is implemented by a network device storing first and second tables and including an ASIC and a CPU, and includes: the ASIC obtaining an incoming flow key when receiving an incoming packet; when the incoming flow key conforms with a flow key contained in a conformed flow entry of the first table, the ASIC updating a packet count, a byte count and a timestamp contained in the conformed flow entry; when the incoming flow key conforms with no flow key in the first table, the ASIC sending a mirrored copy of incoming packet to the CPU; and upon receiving the mirrored copy of incoming packet, the CPU updating the packet count, the byte count and the timestamp contained in one flow entry of the second table that contains the flow key conforming with the incoming flow key contained in the mirrored copy of incoming packet.

### CROSS-REFERENCE TO RELATED APPLICATION

This application claims priority to Taiwanese Invention patent application No. 114116073, filed on Apr. 29, 2025, the entire disclosure of which is incorporated by reference herein.

### FIELD

The disclosure relates to a method and a network device for monitoring data flows on a computer network.

### BACKGROUND

A conventional network switch for monitoring data flows on a computer network includes, for a data plane of the computer network, an application-specific integrated circuit (ASIC), counters and registers. For each of the data flows, the ASIC utilizes one of the counters to generate statistical data related to the data flow and utilizes one of the registers to store the statistical data thus generated. Although the ASIC has a high-speed processing capability, the registers have a limited storage capacity. Thus, the conventional network switch is only capable of simultaneously monitoring a limited number of data flows. In other words, when a large number of active data flows exist on a high-speed network at the same time, the conventional network switch may be incapable of monitoring all of the active data flows.

To address the above-mentioned issue, some have proposed a solution of utilizing a remote server that is connected to the conventional network switch to assist the conventional network switch in monitoring data flows. The remote server includes a central processing unit (CPU) and features an abundant storage capacity. In response to receipt of each incoming packet from a client communicating with the conventional network switch, the conventional network switch mirrors the incoming packet to generate a mirror copy of incoming packet, and sends the mirror copy of incoming packet thus generated to the remote server to enable the CPU of the remote server to monitor one of the data flows to which the incoming packet belongs. In spite of mitigating the issue of storage capacity, such solution generates additional data flows on the computer network that arise from transmission of the mirror copy of incoming packet between the conventional network switch and the remote server. Especially in a high-speed network environment of high packet rates, it may be impossible for the CPU of the remote server to process all received packets due to a heavy workload imposed on the CPU, resulting in packet loss. A technique of packet sampling was proposed to alleviate the workload imposed on the CPU, where only a small ratio (e.g., one out of a hundred) of incoming packets are mirrored and sent to the remote server for monitoring. However, the technique of packet sampling is detrimental to completeness and accuracy of statistical data generated based on monitored data flows. In addition, short-lived data flows, which exist only for a short time and have only a few packets transferred during their lives, may never be monitored when the technique of packet sampling is adopted.

### SUMMARY

Therefore, an object of the disclosure is to provide a method and a network device for monitoring data flows on a computer network that can alleviate at least one of the drawbacks of the prior art.

According to one aspect of the disclosure, the method is adapted to be implemented by a network device. The network device includes an application-specific integrated circuit (ASIC) for a data plane of the computer network and a central processing unit (CPU) for a control plane of the computer network. The network device stores a first table corresponding to the data plane and a second table corresponding to the control plane. Each of the first table and the second table is configured to record a plurality of flow entries that are related respectively to the data flows. Each of the plurality of flow entries contains at least a flow key related to the corresponding one of the data flows, a packet count related to the corresponding one of the data flows, a byte count of all received packets belonging to the corresponding one of the data flows, and a timestamp of a latest packet in the corresponding one of the data flows. The method includes steps of:
in response to receiving an incoming packet, analyzing, by the ASIC, a header of the incoming packet to obtain an incoming flow key related to one of the data flows to which the incoming packet belongs;
in a case that the ASIC determines that the incoming flow key thus obtained conforms with the flow key contained in a conformed flow entry among the plurality of flow entries of the first table, updating, by the ASIC (8), the packet count, the byte count and the timestamp contained in the conformed flow entry of the first table;
in a case that the ASIC determines that the incoming flow key thus obtained does not conform with any flow key contained in each of the plurality of flow entries of the first table, executing, by the ASIC, a send-to-CPU procedure that includes
   mirroring the incoming packet to obtain a mirrored copy of incoming packet,
   modifying the mirrored copy of incoming packet by adding into the mirrored copy of incoming packet the incoming flow key thus obtained, a packet length of the incoming packet and a timestamp of the incoming packet, and
   sending the mirrored copy of incoming packet thus modified to the CPU; and
in response to receipt of the mirrored copy of incoming packet, updating, by the CPU, at least based on the packet length and the timestamp contained in the mirrored copy of incoming packet, the packet count, the byte count and the timestamp contained in one of the plurality of flow entries of the second table that contains the flow key conforming with the incoming flow key contained in the mirrored copy of incoming packet.

According to another aspect of the disclosure, the network device stores a first table corresponding to a data plane of the computer network and a second table corresponding to a control plane of the computer network. Each of the first table and the second table is configured to record a plurality of flow entries that are related respectively to the data flows. Each of the plurality of flow entries contains at least a flow key related to the corresponding one of the data flows, a packet count related to the corresponding one of the data flows, a byte count of all received packets belonging to the corresponding one of the data flows, and a timestamp of a latest packet in the corresponding one of the data flows. The network device includes an application-specific integrated circuit (ASIC) for the data plane, and a central processing unit (CPU) for the control plane. The ASIC and the CPU communicate with each other via a CPU interface, and are configured to cooperatively implement the method that is previously described.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIGS. 1 and 3 are block diagrams cooperatively illustrating a network device for monitoring data flows on a computer network according to an embodiment of the disclosure.

FIGS. 2 and 4 to 6 are flow charts cooperatively illustrating a method for monitoring data flows on a computer network according to an embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

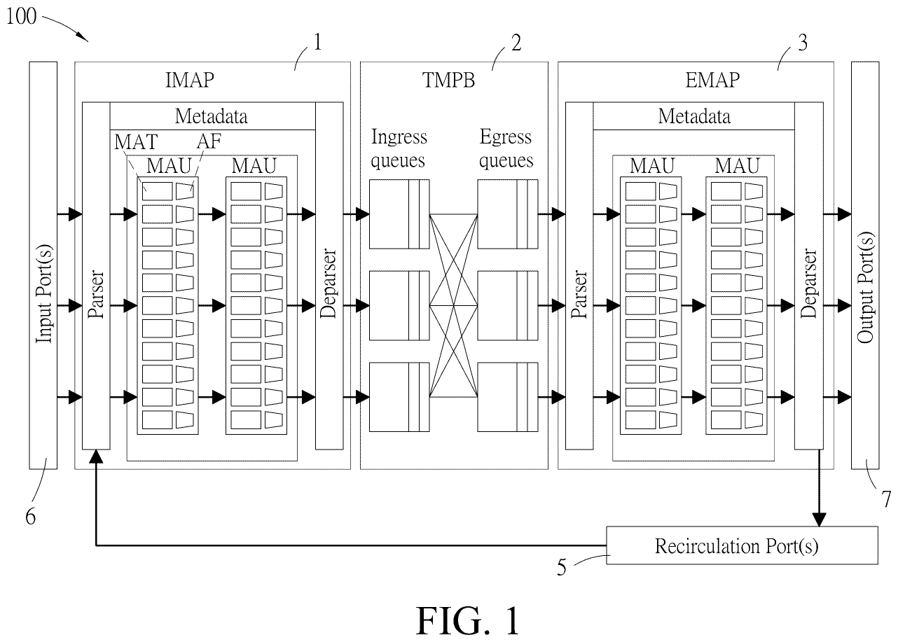

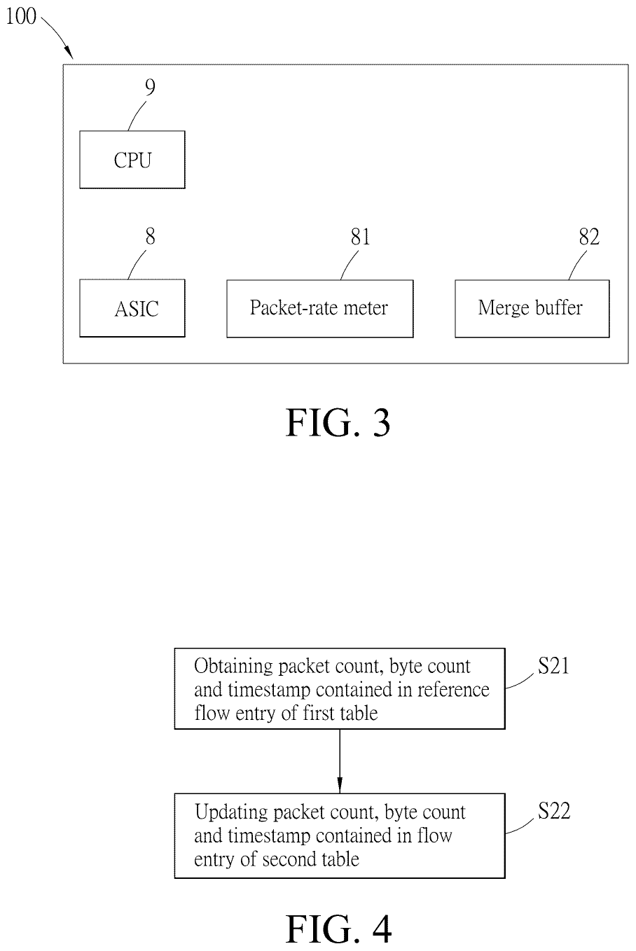

Referring to FIGS. 1 and 3, an embodiment of a network device 100 for monitoring data flows on a computer network according to the disclosure is illustrated. In this embodiment, the network device 100 is implemented by a Programming Protocol-independent Packet Processors (P4) hardware switch (more specifically, the Intel® Tofino™ Ethernet switch ASIC), but is not limited thereto. It is worthy of note that P4 is a domain-specific language, and is a programmable data plane technology allowing developers to design and realize packet processing logics in a data plane of the computer network. As shown in FIG. 3, the network device 100 includes an application-specific integrated circuit (ASIC) 8 for the data plane, and a central processing unit (CPU) 9 for a control plane of the computer network. The ASIC 8 and the CPU 9 communicate with each other via a CPU interface (not shown) of an API library of the network device 100. In some embodiments, the network device 100 may be implemented to be a network switch, a network interface card, a router, and so on.

An architecture of the network device 100 on the data plane of the computer network is illustrated in FIG. 1. The network device 100 includes an ingress match-action pipeline (IMAP) module 1, a traffic manager and packet buffer (TMPB) module 2, an egress match-action pipeline (EMAP) module 3, a mirror buffer 4, a recirculation port 5, at least one input port 6 and at least one output port 7. The IMAP module 1 is electrically connected to the at least one input port 6. The TMPB module 2 is electrically connected to the IMAP module 1. The EMAP module 3 is electrically connected to the TMPB module 2 and the at least one output port 7. The mirror buffer 4 is electrically connected to the IMAP module 1, the TMPB module 2 and the EMAP module 3. The recirculation port 5 is electrically connected to the IMAP module 1 and the EMAP module 3.

The IMAP module 1 is configured to receive packets from client devices (not shown) communicating with the network device 100, and to send the packets thus received to the TMPB module 2. In addition, the IMAP module 1 is further configured to receive a recirculated packet from the EMAP module 3 via the recirculation port 5.

In brief, after a to-be-forwarded packet is received via the at least one input port 6, the to-be-forwarded packet will be sequentially processed by the IMAP module 1, the TMPB module 2 and the EMAP module 3, and then outputted via the at least one output port 7. After a to-be-recirculated packet is generated, the to-be-recirculated packet will be recirculated via the recirculation port 5 from the EMAP module 3 to the IMAP module 1, and then be sequentially processed by the IMAP module 1 and the TMPB module 2.

Each of the IMAP module 1 and the EMAP module 3 includes a parser, a plurality of match-action units (MAUs) and a deparser. The parser is configured to divide each incoming packet to obtain a header of the incoming packet, to extract information contained in the header of the incoming packet, and to pass the incoming packet to the MAUs. Each of the MAUs is realized by a set of match-action tables (MATs) and action functions (AFs). The MATs are defined by a set of match keys (e.g., information contained in a header of a packet, or an instance of intrinsic metadata that is used for matching and that is assigned by the network device 100 to a packet), and the AFs are operations to be applied to a packet. Each of the MAUs is configured to process the incoming packet based on the MATs. The deparser is configured to reassemble the incoming packet processed by the MAU, and to output the incoming packet.

The TMPB module 2 includes multiple ingress queues related to the at least one input port 6, multiple egress queues related to the at least one output port 7, and multiple scheduling functions for carrying out specific functionalities of this disclosure.

It is worth noting that intrinsic metadata is a data structure that is used to describe a current state of a packet or to specify an operation to be applied to a packet. For example, for each incoming packet, the IMAP module 1 is configured to generate an instance of intrinsic metadata so as to assign to the incoming packet an output port ID of one of the at least one output port 7, and an egress queue ID of one of the egress queues. The incoming packet will be enqueued onto one of egress queues for being outputted via said one of the at least one output port 7 based on the output port ID and the egress queue ID.

It should be noted that each of the IMAP module 1, the TMPB module 2 and the EMAP module 3 may be implemented by one of hardware, firmware, software, and any combination thereof. In particular, the above-mentioned modules may be embodied in: executable software as a set of logic instructions stored in a machine-readable or computer-readable storage medium of a memory such as random access memory (RAM), read only memory (ROM), programmable ROM (PROM), firmware, flash memory, etc.; configurable logic such as programmable logic arrays (PLAs), field programmable gate arrays (FPGAs), complex programmable logic devices (CPLDs), etc.; fixed-functionality logic hardware using circuit technology such as application-specific integrated circuit (ASIC), complementary metal oxide semiconductor (CMOS), transistor-transistor logic (TTL) technology, etc.; or any combination thereof. For example, the IMAP module 1, the TMPB module 2 and the EMAP module 3 may be implemented to be software modules in a program, where the software modules contain codes and instructions to carry out specific functionalities, and can be called individually or together to fulfill functionalities of the network device 100 of this disclosure.

The mirror buffer 4 may be implemented by RAM, ROM, double data rate synchronous dynamic random access memory (DDR SDRAM), programmable ROM (PROM), flash memory, a hard disk drive (HDD), a solid state disk (SSD), electrically-erasable programmable read-only memory (EEPROM) or any other volatile/non-volatile memory devices, but is not limited thereto.

The network device 100 stores a first table, a second table and a third table. The first table corresponds to the data plane of the computer network, and is also known as a Cache table, a Count table or a Flow table. The second table corresponds to the control plane of the computer network, and is known as an Active table or a Hash table. The third table corresponds to the data plane of the computer network, and is also known as an Evict table. Each of the first table, the second table and the third table is configured to record a plurality of flow entries that are related respectively to the data flows. Each of the plurality of flow entries contains at least a flow key related to the corresponding one of the data flows, a packet count related to the corresponding one of the data flows, a byte count of all received packets belonging to the corresponding one of the data flows, and a timestamp of a latest packet in the corresponding one of the data flows. For each of the flow entries of the first table and the second table, the network device 100 further includes a packet counter for counting a number of packets for the flow entry, a byte counter for counting a number of bytes of packets for the flow entry, and a timestamp register for recording timestamps of packets for the flow entry, wherein each of the packet counter, the byte counter and the timestamp register may be realized by static random access memory (SRAM), but is not limited thereto.

The network device 100 further stores a waiting queue corresponding to the control plane. The waiting queue is a priority queue.

The network device 100 further includes a merge buffer 82, and a packet-rate meter 81 (which is also known as a Meter table) for monitoring a gross packet rate of the data flows, wherein the merge buffer 82 and the packet-rate meter 81 both correspond to the data plane. The packet-rate meter 81 is implemented to include a counter. A value of the counter is repeatedly increased by one at a preset frequency (e.g., 390000 Hz), i.e., the value of the counter is increased by one every 1/390000 seconds, until the value of the counter reaches a preset maximum value (e.g., 100). Moreover, the value of the counter will be decreased by one whenever a packet passes through the packet-rate meter 81, until the value of the counter reaches zero. As a result, the value of the counter being zero means that a current packet rate is greater than the preset frequency (i.e., 390000 packets/sec).

It is worthy of note that each of the first table, the third table, the merge buffer 82 and the packet-rate meter 81 is implemented by the MATs of the IMAP module 1.

Since the P4 hardware switch has been well known to one skilled in the relevant art, detailed explanation of the same is omitted herein for the sake of brevity.

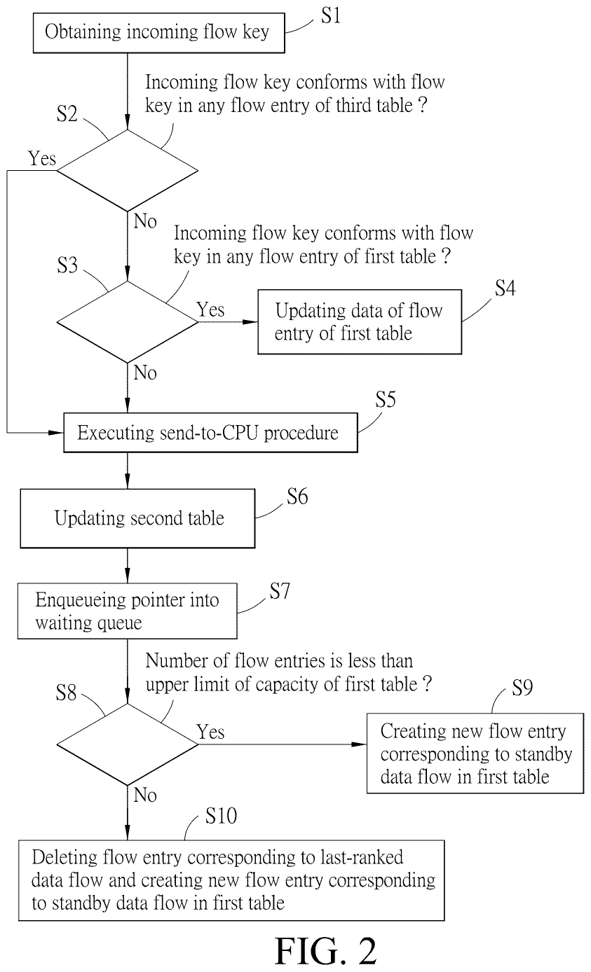

Referring to FIGS. 2 and 4 to 6, an embodiment of a method for monitoring data flows on a computer network according to the disclosure is illustrated. The method is adapted to be implemented by the network device 100 that is previously described. The method includes steps S1 to S10 delineated below.

In step S1, in response to receiving an incoming packet via one of said at least one input port 6, the ASIC 8 analyzes a header of the incoming packet to obtain an incoming flow key related to one of the data flows to which the incoming packet belongs. The incoming flow key contains five components: information of a source Internet Protocol (IP) address for the one of the data flows; a destination IP address for the one of the data flows; a protocol value representing a protocol used in the one of the data flows; one of said at least one input port 6 (which is denoted by a number) for the one of the data flows; and one of said at least one output port 7 (which is denoted by a number) for the one of the data flows. For example, the protocol value of six represents the Transmission Control Protocol (TCP), and the protocol value of seventeen represents the User Datagram Protocol (UDP). In a scenario where the source IP address for a data flow is “10.10.1.4”, the destination IP address for the data flow is “10.10.1.9”, the protocol value is six, one of said at least one input port 6 for the data flow is 11544, and one of said at least one output port 7 for the data flow is 80, the flow key can be express as (10.10.1.4, 10.10.1.9, 6, 11544, 80).

In step S2, the ASIC 8 determines whether the incoming flow key obtained from the incoming packet conforms with the flow key (hereinafter also referred to as a compared flow key) contained in any one of the flow entries of the third table. In the case that the ASIC 8 determines that the incoming flow key obtained from the incoming packet conforms with the flow key contained in one of the flow entries of the third table, a procedure flow of the method proceeds to step S5. On the other hand, in the case that the ASIC 8 determines that the incoming flow key obtained from the incoming packet does not conform with the flow key contained in each of the flow entries of the third table, the procedure flow proceeds to step S3. For example, an entry of the third table may contain an entry number of two, a key value of (10.10.1.4, 10.10.1.9, 6, 11544, 80), and an action description of “send to CPU”. It should be noted that in this embodiments, in any determination as to whether the incoming flow key conforms with another flow key (e.g., the compared flow key mentioned above), the five components of the incoming flow key are compared respectively to the five components of said another flow key, and the incoming flow key is determined to conform with said another flow key when all of the five components of the incoming flow key conform respectively with all of the five components of said another flow key. That is to say, the five components of the incoming flow key are compared with the five components of said another flow key.

In step S3, the ASIC 8 determines whether the incoming flow key thus obtained in step S1 conforms with the flow key contained in any one of the flow entries of the first table. In a case that the ASIC 8 determines that the incoming flow key conforms with the flow key contained in one of the flow entries (hereinafter also referred to as a conformed flow entry) of the first table, the procedure flow proceeds to step S4. Oppositely, in a case that the ASIC 8 determines that the incoming flow key does not conform with any flow key contained in each of the flow entries of the first table, the procedure flow proceeds to step S5. For example, an entry of the first table may contain an entry number of one, a key value of (10.10.1.4, 10.10.1.9, 6, 11544, 80), an action description of “update data”, a packet count of zero, a byte count of zero, and a timestamp of a latest packet of zero.

In step S4, the ASIC 8 updates the packet count, the byte count and the timestamp contained in the conformed flow entry of the first table. Specifically, the ASIC 8 increases the packet count by one, increases the byte count by a packet length of the incoming packet, and revises the timestamp to be a timestamp of the incoming packet.

In step S5, the ASIC 8 executes a send-to-CPU procedure. Specifically, in the send-to-CPU procedure, the ASIC 8 mirrors the incoming packet to obtain a mirrored copy of incoming packet, modifies the mirrored copy of incoming packet, and sends the mirrored copy of incoming packet thus modified to the CPU 9. In this embodiment, the ASIC 8 modifies the mirrored copy of incoming packet by adding into the mirrored copy of incoming packet the incoming flow key thus obtained in step S1, the packet length of the incoming packet and the timestamp of the incoming packet. However, implementation of the send-to-CPU procedure is not limited to the disclosure herein and may vary in other embodiments. It is worthy of note that the mirrored copy of incoming packet thus modified is sent to the CPU 9 via the CPU interface.

In one embodiment, after mirroring the incoming packet to obtain the mirrored copy of incoming packet, the ASIC 8 stores, in the merge buffer 82, a combination of the incoming flow key derived from the incoming packet, the packet length of the incoming packet and the timestamp of the incoming packet as a flow header. In response to determining that a number of flow headers stored by the ASIC 8 in the merge buffer 82 is equal to a preset merge number (e.g., three), the ASIC 8 modifies the mirrored copy of incoming packet by adding the flow headers stored in the merge buffer 82 into the mirrored copy of incoming packet, and then sends the mirrored copy of incoming packet thus modified to the CPU 9. It is worthy of note that in this embodiment, packet loss occurring when there are a large number of packets being transmitted from the ASIC 8 to the CPU 9 at a high packet rate due to hardware limitations may be alleviated.

In one embodiment, in the send-to-CPU procedure, the ASIC 8 determines, by utilizing the packet-rate meter 81, whether or not the gross packet rate is currently less than a gross-packet-rate threshold (e.g., 390000 packets/sec). It should be noted that when the preset frequency at which the value of the counter of the packet-rate meter 81 is increased is equal to the gross-packet-rate threshold, the value of the counter will be zero when the gross packet rate is not less than the gross-packet-rate threshold. In a case that the ASIC 8 determines that the gross packet rate is not currently less than the gross-packet-rate threshold (i.e., the value of the counter is equal to zero), the ASIC 8 recirculates the mirrored copy of incoming packet thus modified via the recirculation port 5. Otherwise, in a case that the ASIC 8 determines that the gross packet rate is currently less than the gross-packet-rate threshold, the ASIC 8 sends the mirrored copy of incoming packet thus modified in step S5 to the CPU 9. In this way, the mirrored copy of incoming packet will be sent from the ASIC 8 to the CPU 9 when the gross packet rate is relatively low.

In step S6, in response to receipt of the mirrored copy of incoming packet from the ASIC 8, the CPU 9 determines whether the incoming flow key contained in the mirrored copy of incoming packet conforms with any flow key contained in each of the plurality of flow entries of the second table. For example, an entry of the second table may contain an entry number of three, a key value of (10.10.1.5, 10.10.1.2, 6, 80, 11234), a packet count of three, a byte count of 2437, a timestamp of a first packet of 1500000, a timestamp of a latest packet of 1700000, and a per-flow packet rate of six packets per second (PPS). In a case that the CPU 9 determines that the incoming flow key contained in the mirrored copy of incoming packet does not conform with any flow key contained in each of the flow entries of the second table, the CPU 9 creates a new flow entry in the second table such that the new flow entry contains a flow key identical to the incoming flow key contained in the mirrored copy of incoming packet, a byte count equal to the packet length contained in the mirrored copy of incoming packet, and a timestamp of a first packet and a timestamp of a latest packet both identical to the timestamp contained in the mirrored copy of incoming packet. Alternatively, in a case that the CPU 9 determines that the incoming flow key contained in the mirrored copy of incoming packet conforms with the flow key contained in one of the flow entries (hereinafter also referred to as an incoming flow entry) of the second table that contains the flow key conforming with the incoming flow key contained in the mirrored copy of incoming packet, the CPU 9 updates the packet count, the byte count and the timestamp of the latest packet contained in the incoming flow entry of the second table at least based on the packet length and the timestamp contained in the mirrored copy of incoming packet. Specifically, the CPU 9 increases the packet count by one, increases the byte count by the packet length contained in the mirrored copy of incoming packet, and revises the timestamp of the latest packet to be the timestamp contained in the mirrored copy of incoming packet.

In step S7, for each of the data flows, the CPU 9 calculates a per-flow packet rate of the data flow, and in a case that the CPU 9 determines that none of the flow entries of the first table corresponds to the data flow and that a per-flow packet rate of the data flow is not less than a per-flow-packet-rate threshold (e.g., five packets per second), the CPU 9 enqueues a pointer that corresponds to the data flow into the waiting queue. It should be noted that the CPU 9 is capable of identifying one of the data flows according to the pointer corresponding to the one of the data flows.

In step S8, the CPU 9 determines whether a number of flow entries currently recorded by the first table is less than an upper limit of a capacity of the first table. In a case that the CPU 9 determines that a number of flow entries currently recorded by the first table is less than the upper limit of the capacity of the first table, the procedure flow proceeds to step S9. Contrarily, in a case that the CPU 9 determines that the number of flow entries currently recorded by the first table is not less than the upper limit of the capacity of the first table, the procedure flow proceeds to step S10.

In step S9, the CPU 9 selects a standby data flow that has a highest per-flow packet rate from among the data flows respectively corresponding to pointers in the waiting queue. Then, the CPU 9 removes the pointer that corresponds to the standby data flow from the waiting queue, and creates a new flow entry that corresponds to the standby data flow in the first table.

In step S10, the CPU 9 selects a last-ranked data flow that has a lowest per-flow packet rate from among the data flows which correspond respectively to the flow entries of the first table. Subsequently, the CPU 9 determines whether the per-flow packet rate of the standby data flow is higher than the per-flow packet rate of the last-ranked data flow. In a case that the CPU 9 determines that the per-flow packet rate of the standby data flow is higher than the per-flow packet rate of the last-ranked data flow, the CPU 9 deletes one of the flow entries of the first table that corresponds to the last-ranked data flow, and the CPU 9 creates the new flow entry that corresponds to the standby data flow in the first table. Consequently, the last-ranked data flow will now be monitored by the CPU 9, and the standby data flow will now be monitored by the ASIC 8.

The method further includes an updating procedure. Particularly, every preset time period (e.g., every second), the CPU 9 executes the updating procedure for each flow entry among the flow entries of the second table. The updating procedure includes steps S21 and S22 as shown in FIG. 4 and delineated below.

In step S21, the CPU 9 obtains the packet count, the byte count and the timestamp of a latest packet contained in a reference flow entry among the flow entries in the first table where the reference flow entry in the first table contains the flow key conforming with the flow key contained in the flow entry of the second table.

In step S22, the CPU 9 updates the packet count, the byte count and the timestamp of a latest packet contained in the flow entry of the second table based on the packet count, the byte count and the timestamp thus obtained in step S21. Specifically, the CPU 9 replaces the packet count contained in the flow entry of the second table with the packet count obtained in step S21, replaces the byte count contained in the flow entry of the second table with the byte count obtained in step S21, and replaces the timestamp of the latest packet contained in the flow entry of the second table with the timestamp obtained in step S21. In practice, every second, the CPU 9 issues a “sync” runtime API command to synchronize the reference flow entry and a shadow stored in a runtime API library of the network device 100, and after the synchronization is done, uses the shadow to update the content (i.e., the packet count, the byte count, the timestamp of the latest packet, and so on) of the flow entry of the second table.

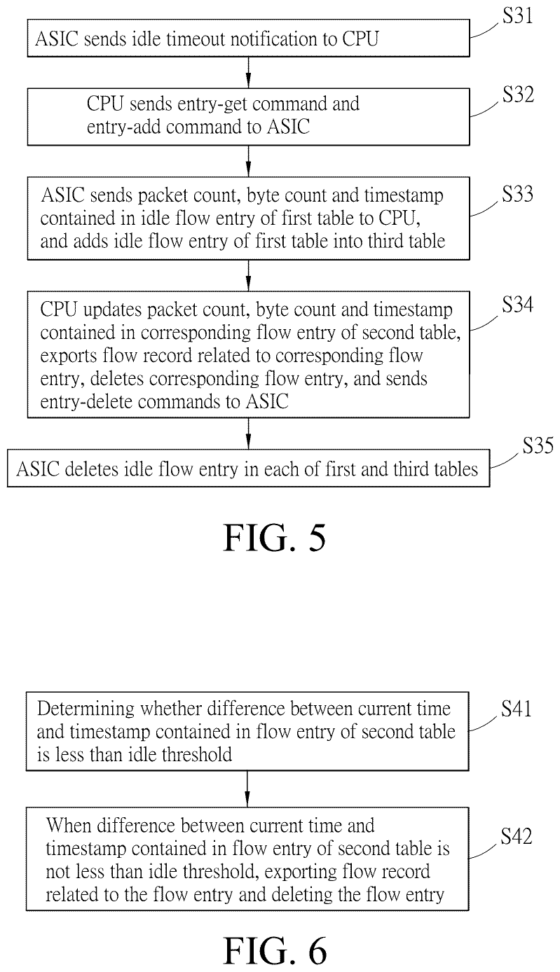

The method further includes an idle detection procedure. In particular, the ASIC 8 repeatedly determines whether a difference between a current time and the timestamp of a latest packet contained in each of the flow entries of the first table is not less than an idle threshold (e.g., 15 seconds). In a case that the ASIC 8 determines that a difference between a current time and the timestamp of a latest packet contained in one of the flow entries (hereinafter also referred to as an idle flow entry) of the first table is not less than the idle threshold, the ASIC 8 and the CPU 9 cooperatively execute the idle detection procedure that includes steps S31 to S35 as shown in FIG. 5 and delineated below.

In step S31, the ASIC 8 sends an idle timeout notification to the CPU 9.

In step S32, in response to receipt of the idle timeout notification from the ASIC 8, the CPU 9 sends an entry-get command to the ASIC 8. At the same time, the CPU 9 sends an entry-add command along with the entry-get command to the ASIC 8.

In step S33, in response to receipt of the entry-get command from the CPU 9, the ASIC 8 sends the packet count, the byte count and the timestamp of the latest packet contained in the idle flow entry of the first table to the CPU 9. Moreover, in response to receipt of the entry-add command from the CPU 9, the ASIC 8 adds the idle flow entry of the first table into the third table.

In step S34, in response to receipt of the packet count, the byte count and the timestamp of the latest packet from the ASIC 8, the CPU 9 updates, based on the packet count, the byte count and the timestamp of the latest packet thus received, the packet count, the byte count and the timestamp of the latest packet contained in one of the flow entries (hereinafter also referred to as a corresponding flow entry) of the second table that contains the flow key conforming with the flow key contained in the idle flow entry of the first table. Specifically, the CPU 9 adds the packet count thus received to the packet count contained in the corresponding flow entry of the second table, and adds the byte count thus received to the byte count contained in the corresponding flow entry of the second table. Further, when the CPU 9 determines that the timestamp thus received is greater than the timestamp of the latest packet contained in the corresponding flow entry of the second table, the CPU 9 replaces the timestamp of the latest packet contained in the corresponding flow entry of the second table with the timestamp thus received. In addition, the CPU 9 exports a flow record related to the flow entry of the second table thus updated by saving updated data of the flow entry of the second table in another format usable by other software programs, and deletes the flow entry of the second table thus exported. Moreover, the CPU 9 sends a first entry-delete command to the ASIC 8, and sends a second entry-delete command along with the first entry-delete command to the ASIC 8.

In step S35, in response to receipt of the first entry-delete command from the CPU 9, the ASIC 8 deletes the idle flow entry of the first table. Similarly, in response to receipt of the second entry-delete command from the CPU 9, the ASIC 8 deletes the flow entry thus added in step S33 to the third table.

It is worthy of note that the third table used in step S2 and the idle detection procedure is to solve an issue of discrepancy between the first table and the second table caused by latency in communication between the ASIC 8 and the CPU 9. For explanation, in a scenario where the third table is omitted, and the ASIC 8 sends the content (i.e., the packet count, the byte count, the timestamp of the latest packet, and so on) of the idle flow entry in the first table to the CPU 9 for updating the content of the corresponding flow entry in the second table at a first time instant and the ASIC 8 deletes the idle flow entry at a second time instant, when a residual packet belonging to one of the data flows to which the idle flow entry corresponds arrives at the network device 100 between a time span from the first time instant to the second time instant, the ASIC 8 would update the content of the idle flow entry according to the arrival of the residual packet but would not send the updated content of the idle flow entry to the CPU 9 for updating the content of the corresponding flow entry. That is to say, utilization of the third table could help catch such residual packet for updating the content of the corresponding flow entry.

The method further includes a clearance procedure. The clearance procedure includes, for each of the flow entries of the second table, steps S41 and S42 as shown in FIG. 6 and delineated below.

In step S41, the CPU 9 repeatedly determines whether a difference between a current time and a timestamp of a latest packet contained in the flow entry of the second table is not less than the idle threshold. In a case that the CPU 9 determines that the difference is not less than the idle threshold, the procedure flow proceeds to step S42.

In step S42, the CPU 9 exports a flow record related to the flow entry of the second table, and deletes the flow entry of the second table.

To sum up, in the method and the network device 100 for monitoring data flows on a computer network according to the disclosure, the ASIC 8 of the network device 100 is utilized to manage, in the first table corresponding to the data plane of the computer network, flow entries that correspond respectively to a part of the data flows which have relatively high packet rates (specifically, in view of packet-per-second, PPS), and the CPU 9 of the network device 100 is utilized to manage, in the second table corresponding to the control plane of the computer network, flow entries that correspond respectively to all of the data flows. In this way, efficiency of monitoring the data flows, and completeness and accuracy of statistical data (i.e., the packet counts, the byte counts and the timestamps of latest packets and so on) related to the data flows may be ensured as well. It is worthy of note that with the assistance of the third table, packet loss occurring while moving an entry from the first table to the second table may be prevented. Moreover, use of the waiting queue helps ensure that data flows having relatively high packet rates have respective flow entries in the first table, thereby increasing the hit rate of the first table and reducing workload imposed on the CPU 9. Furthermore, utilizing the packet-rate meter 81 and the merge buffer 82 may help reduce the amount of data transmission between the ASIC 8 and the CPU 9, and a hardware bottleneck for implementing data transmission between the ASIC 8 and the CPU 9 may be overcome.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for monitoring data flows on a computer network, adapted to be implemented by a network device that includes an application-specific integrated circuit (ASIC) for a data plane of the computer network and a central processing unit (CPU) for a control plane of the computer network, and that stores a first table corresponding to the data plane and a second table corresponding to the control plane, each of the first table and the second table being configured to record a plurality of flow entries that are related respectively to the data flows, each of the plurality of flow entries containing at least a flow key related to the corresponding one of the data flows, a packet count related to the corresponding one of the data flows, a byte count of all received packets belonging to the corresponding one of the data flows, and a timestamp of a latest packet in the corresponding one of the data flows, the method comprising:
in response to receiving an incoming packet, analyzing, by the ASIC, a header of the incoming packet to obtain an incoming flow key related to one of the data flows to which the incoming packet belongs;
in a case that the ASIC determines that the incoming flow key thus obtained conforms with the flow key contained in a conformed flow entry among the plurality of flow entries of the first table, updating, by the ASIC, the packet count, the byte count and the timestamp contained in the conformed flow entry of the first table;
in a case that the ASIC determines that the incoming flow key thus obtained does not conform with any flow key contained in each of the plurality of flow entries of the first table, executing, by the ASIC, a send-to-CPU procedure that includes
mirroring the incoming packet to obtain a mirrored copy of incoming packet,
modifying the mirrored copy of incoming packet by adding into the mirrored copy of incoming packet the incoming flow key thus obtained, a packet length of the incoming packet and a timestamp of the incoming packet, and
sending the mirrored copy of incoming packet thus modified to the CPU; and
in response to receipt of the mirrored copy of incoming packet, updating, by the CPU, at least based on the packet length and the timestamp contained in the mirrored copy of incoming packet, the packet count, the byte count and the timestamp contained in one of the plurality of flow entries of the second table that contains the flow key conforming with the incoming flow key contained in the mirrored copy of incoming packet.

2. The method as claimed in claim 1, the network device further including at least one input port and at least one output port, wherein the incoming flow key contains information of a source Internet Protocol (IP) address for the one of the data flows, a destination IP address for the one of the data flows, a protocol value representing a protocol used in the one of the data flows, one of said at least one input port for the one of the data flows, and one of said at least one output port for the one of the data flows.

3. The method as claimed in claim 1, further comprising, in a case that the ASIC determines that a difference between a current time and the timestamp of a latest packet contained in an idle flow entry among the plurality of flow entries of the first table is not less than an idle threshold, executing, cooperatively by the ASIC and the CPU, an idle detection procedure that includes:
sending, by the ASIC, an idle timeout notification to the CPU to enable the CPU to send an entry-get command to the ASIC;
in response to receipt of the entry-get command from the CPU, sending, by the ASIC, the packet count, the byte count and the timestamp of the latest packet contained in the idle flow entry of the first table to the CPU;
in response to receipt of the packet count and the byte count from the ASIC,
updating, by the CPU, based on the packet count, the byte count and the timestamp of the latest packet thus received, the packet count, the byte count and the timestamp of the latest packet contained in one of the plurality of flow entries of the second table that contains the flow key conforming with the flow key contained in the idle flow entry of the first table,
exporting, by the CPU, a flow record related to the flow entry of the second table thus updated, and deleting, by the CPU, the flow entry of the second table thus exported, and
sending, by the CPU, a first entry-delete command to the ASIC; and
in response to receipt of the first entry-delete command from the CPU, deleting, by the ASIC, the idle flow entry of the first table.

4. The method as claimed in claim 3, the network device further storing a third table corresponding to the data plane, wherein the idle detection procedure further includes:
further sending, by the CPU, an entry-add command to the ASIC along with the entry-get command, the entry-add command enabling the ASIC to add the idle flow entry of the first table into the third table; and
further sending, by the CPU, a second entry-delete command to the ASIC along with the first entry-delete command, the second entry-delete command enabling the ASIC to delete the flow entry thus added to the third table,
wherein the send-to-CPU procedure is also executed in the case that the ASIC determines that the incoming flow key obtained from the incoming packet conforms with the flow key contained in one of one or more flow entries of the third table.

5. The method as claimed in claim 1, the network device further including a merge buffer, wherein the send-to-CPU procedure further includes:
after mirroring the incoming packet to obtain the mirrored copy of incoming packet, storing, by the ASIC in the merge buffer, a combination of the incoming flow key derived from the incoming packet, the packet length of the incoming packet and the timestamp of the incoming packet as a flow header,
wherein modifying the mirrored copy of incoming packet includes, in response to determining that a number of flow headers stored by the ASIC in the merge buffer is equal to a preset merge number, adding the flow headers stored in the merge buffer into the mirrored copy of incoming packet.

6. The method as claimed in claim 5, the network device further including a recirculation port and a packet-rate meter for monitoring a gross packet rate of the data flows, wherein the send-to-CPU procedure further includes:
recirculating the mirrored copy of incoming packet thus modified via the recirculation port in a case that the ASIC determines that, utilizing the packet-rate meter, the gross packet rate is not less than a gross-packet-rate threshold,
wherein sending the mirrored copy of incoming packet thus modified to the CPU is implemented in a case that the ASIC determines that, utilizing the packet-rate meter, the gross packet rate is less than the gross-packet-rate threshold.

7. The method as claimed in claim 1, further comprising, in response to receipt of the mirrored copy of incoming packet:
in a case that the CPU determines that the incoming flow key contained in the mirrored copy of incoming packet does not conform with any flow key contained in each of the plurality of flow entries of the second table, creating a new flow entry in the second table such that the new flow entry contains a flow key identical to the incoming flow key contained in the mirrored copy of incoming packet, a byte count equal to the packet length contained in the mirrored copy of incoming packet, and a timestamp of a first packet and a timestamp of a latest packet both identical to the timestamp contained in the mirrored copy of incoming packet,
wherein updating the packet count, the byte count and the timestamp contained in one of the plurality of flow entries of the second table includes, in a case that the CPU determines that the incoming flow key contained in the mirrored copy of incoming packet conforms with the flow key contained in an incoming flow entry among the plurality of flow entries of the second table that contains the flow key conforming with the incoming flow key contained in the mirrored copy of incoming packet, updating the packet count, the byte count and the timestamp of the latest packet contained in the incoming flow entry of the second table.

8. The method as claimed in claim 7, further comprising, every preset time period, executing, by the CPU, an updating procedure for each flow entry among the plurality of flow entries of the second table, the updating procedure including:
obtaining the packet count, the byte count and the timestamp of a latest packet contained in a reference flow entry among the plurality of flow entries in the first table where the reference flow entry in the first table contains the flow key conforming with the flow key contained in the flow entry of the second table; and
updating the packet count, the byte count and the timestamp of a latest packet contained in the flow entry of the second table based on the packet count, the byte count and the timestamp thus obtained.

9. The method as claimed in claim 8, the network device further storing a waiting queue for the control plane, the method further comprising:
for each of the data flows,
calculating, by the CPU, a per-flow packet rate of the data flow, and
in a case that the CPU determines that none of the plurality of flow entries of the first table corresponds to the data flow and that a per-flow packet rate of the data flow is not less than a per-flow-packet-rate threshold, enqueuing, by the CPU, a pointer that corresponds to the data flow into the waiting queue; and
in a case that the CPU determines that a number of flow entries currently recorded by the first table is less than an upper limit of a capacity of the first table,
selecting, by the CPU, a standby data flow that has a highest per-flow packet rate from among the data flows respectively corresponding to pointers in the waiting queue,
removing, by the CPU, the pointer that corresponds to the standby data flow from the waiting queue, and
creating, by the CPU, a new flow entry that corresponds to the standby data flow in the first table.

10. The method as claimed in claim 9, further comprising, in a case that the CPU determines that the number of flow entries currently recorded by the first table is not less than the upper limit of the capacity of the first table:
selecting, by the CPU, a last-ranked data flow that has a lowest per-flow packet rate from among the data flows which correspond respectively to the plurality of flow entries of the first table;
determining, by the CPU, whether the per-flow packet rate of the standby data flow is higher than the per-flow packet rate of the last-ranked data flow; and
in a case that the CPU determines that the per-flow packet rate of the standby data flow is higher than the per-flow packet rate of the last-ranked data flow,
deleting, by the CPU, one of the plurality of flow entries of the first table that corresponds to the last-ranked data flow, and
creating the new flow entry that corresponds to the standby data flow in the first table.

11. The method as claimed in claim 1, further comprising, for each of the plurality of flow entries of the second table:
determining, by the CPU, whether a difference between a current time and a timestamp of a latest packet contained in the flow entry of the second table is not less than an idle threshold; and
in a case that the CPU determines that the difference is not less than the idle threshold, exporting a flow record related to the flow entry of the second table, and deleting the flow entry of the second table.

12. A network device for monitoring data flows on a computer network, storing a first table corresponding to a data plane of the computer network and a second table corresponding to a control plane of the computer network, each of the first table and the second table being configured to record a plurality of flow entries that are related respectively to the data flows, each of the plurality of flow entries containing at least a flow key related to the corresponding one of the data flows, a packet count related to the corresponding one of the data flows, a byte count of all received packets belonging to the corresponding one of the data flows, and a timestamp of a latest packet in the corresponding one of the data flows, said network device comprising:
an application-specific integrated circuit (ASIC) for the data plane; and
a central processing unit (CPU) for the control plane,
wherein said ASIC and said CPU communicate with each other via a CPU interface, and are configured to cooperatively implement the method of claim 1.

13. The network device as claimed in claim 12, further comprising at least one input port and at least one output port, wherein the incoming flow key contains information of a source Internet Protocol (IP) address for the one of the data flows, a destination IP address for the one of the data flows, a protocol value representing a protocol used in the one of the data flows, one of said at least one input port for the one of the data flows, and one of said at least one output port for the one of the data flows.

14. The network device as claimed in claim 12, wherein in a case that said ASIC determines that a difference between a current time and the timestamp of a latest packet contained in an idle flow entry among the plurality of flow entries of the first table is not less than an idle threshold, said ASIC and said CPU cooperatively execute an idle detection procedure that includes:
sending, by said ASIC, an idle timeout notification to said CPU to enable said CPU to send an entry-get command to said ASIC;
in response to receipt of the entry-get command from said CPU, sending, by said ASIC, the packet count, the byte count and the timestamp of the latest packet contained in the idle flow entry of the first table to said CPU;
in response to receipt of the packet count and the byte count from said ASIC,
updating, by said CPU based on the packet count, the byte count and the timestamp of the latest packet thus received, the packet count and the byte count contained in one of the plurality of flow entries of the second table that contains the flow key conforming with the flow key contained in the idle flow entry of the first table,
exporting, by said CPU, a flow record related to the flow entry of the second table thus updated, and deleting, by said CPU, the flow entry of the second table thus exported, and
sending, by said CPU, a first entry-delete command to said ASIC; and
in response to receipt of the first entry-delete command from said CPU, deleting, by said ASIC, the idle flow entry of the first table.

15. The network device as claimed in claim 14, further storing a third table corresponding to the data plane, wherein the idle detection procedure further includes:
further sending, by said CPU, an entry-add command to said ASIC along with the entry-get command, the entry-add command enabling said ASIC to add the idle flow entry of the first table into the third table; and
further sending, by said CPU, a second entry-delete command to said ASIC along with the first entry-delete command, the second entry-delete command enabling said ASIC to delete the flow entry thus added to the third table,
wherein the send-to-CPU procedure is also executed in the case that said ASIC determines that the incoming flow key obtained from the incoming packet conforms with the flow key contained in one of one or more flow entries of the third table.

16. The network device as claimed in claim 12, further comprising a merge buffer, wherein the send-to-CPU procedure further includes:
after mirroring the incoming packet to obtain the mirrored copy of incoming packet, storing, by said ASIC in said merge buffer, a combination of the incoming flow key derived from the incoming packet, the packet length of the incoming packet and the timestamp of the incoming packet as a flow header,
wherein modifying the mirrored copy of incoming packet includes, in response to determining that a number of flow headers stored by said ASIC in said merge buffer is equal to a preset merge number, adding the flow headers stored in said merge buffer into the mirrored copy of incoming packet.

17. The network device as claimed in claim 16, further comprising a recirculation port and a packet-rate meter for monitoring a gross packet rate of the data flows, wherein the send-to-CPU procedure further includes:
recirculating the mirrored copy of incoming packet thus modified via said recirculation port in a case that said ASIC determines that, utilizing said packet-rate meter, the gross packet rate is not less than a gross-packet-rate threshold,
wherein sending the mirrored copy of incoming packet thus modified to said CPU is implemented in a case that said ASIC determines that, utilizing said packet-rate meter, the gross packet rate is less than the gross-packet-rate threshold.

18. The network device as claimed in claim 12, wherein, in response to receipt of the mirrored copy of incoming packet:
in a case that said CPU determines that the incoming flow key contained in the mirrored copy of incoming packet does not conform with any flow key contained in each of the plurality of flow entries of the second table, said CPU creates a new flow entry in the second table such that the new flow entry contains a flow key identical to the incoming flow key contained in the mirrored copy of incoming packet, a byte count equal to the packet length contained in the mirrored copy of incoming packet, and a timestamp of a first packet and a timestamp of a latest packet both identical to the timestamp contained in the mirrored copy of incoming packet,
wherein updating the packet count, the byte count and the timestamp contained in one of the plurality of flow entries of the second table includes, in a case that said CPU determines that the incoming flow key contained in the mirrored copy of incoming packet conforms with the flow key contained in an incoming flow entry among the plurality of flow entries of the second table that contains the flow key conforming with the incoming flow key contained in the mirrored copy of incoming packet, updating the packet count, the byte count and the timestamp of the latest packet contained in the incoming flow entry of the second table.

19. The network device as claimed in claim 18, wherein every preset time period, said CPU executes an updating procedure for each flow entry among the plurality of flow entries of the second table, the updating procedure including:
obtaining the packet count, the byte count and the timestamp of a latest packet contained in a reference flow entry among the plurality of flow entries in the first table where the reference flow entry in the first table contains the flow key conforming with the flow key contained in the flow entry of the second table; and
updating the packet count, the byte count and the timestamp of a latest packet contained in the flow entry of the second table based on the packet count, the byte count and the timestamp thus obtained.

20. The network device as claimed in claim 19, further storing a waiting queue for the control plane, wherein:
for each of the data flows,
said CPU calculates a per-flow packet rate of the data flow, and
in a case that said CPU determines that none of the plurality of flow entries of the first table corresponds to the data flow and that a per-flow packet rate of the data flow is not less than a per-flow-packet-rate threshold, said CPU enqueues a pointer that corresponds to the data flow into the waiting queue; and
in a case that said CPU determines that a number of flow entries currently recorded by the first table is less than an upper limit of a capacity of the first table,
said CPU selects a standby data flow that has a highest per-flow packet rate from among the data flows respectively corresponding to pointers in the waiting queue,
said CPU removes the pointer that corresponds to the standby data flow from the waiting queue, and
said CPU creates a new flow entry that corresponds to the standby data flow in the first table.

21. The network device as claimed in claim 20, wherein, in a case that said CPU determines that the number of flow entries currently recorded by the first table is not less than the upper limit of the capacity of the first table:
said CPU selects a last-ranked data flow that has a lowest per-flow packet rate from among the data flows which correspond respectively to the plurality of flow entries of the first table;
said CPU determines whether the per-flow packet rate of the standby data flow is higher than the per-flow packet rate of the last-ranked data flow; and
in a case that said CPU determines that the per-flow packet rate of the standby data flow is higher than the per-flow packet rate of the last-ranked data flow,
said CPU deletes one of the plurality of flow entries of the first table that corresponds to the last-ranked data flow, and
said CPU creates the new flow entry that corresponds to the standby data flow in the first table.

22. The network device as claimed in claim 12, wherein for each of the plurality of flow entries of the second table:
said CPU determines whether a difference between a current time and a timestamp of a latest packet contained in the flow entry of the second table is not less than an idle threshold; and
in a case that said CPU determines that the difference is not less than the idle threshold, said CPU exports a flow record related to the flow entry of the second table, and deletes the flow entry of the second table.
